(19) United States
(12) Patent Application Publication
(10) Pub. No.: US 2023/0400267 A1
(43) Pub. Date: Dec. 14, 2023

(54) Filtration Systems And Processes For Cooling Tower Systems

(71) Applicant: Arizona Commercial Water Savers LLC, Peoria, AZ (US)

(72) Inventors: Richard P. Webb, Peoria, AZ (US); Ernest C. Hicks, Glendale, AZ (US); John B. Woodroffe, Tempe, AZ (US)

(73) Assignee: Arizona Commercial Water Savers LLC, Peoria, AZ (US)

(21) Appl. No.: 18/209,227

(22) Filed: Jun. 13, 2023

Related U.S. Application Data
(60) Provisional application No. 63/352,072, filed on Jun. 14, 2022.

(51) Int. Cl. F28F 25/02; C02F 1/00; C02F 1/38

(52) U.S. Cl. CPC F28F 25/02; C02F 1/004; C02F 1/38; F28F 2025/005

(57) ABSTRACT

A cooling tower system including a cooling tower housing, a basin and spray nozzles within the cooling tower housing, and a supply pipe configured to transmit a fluid from the basin to the spray nozzles. A filter loop is coupled to the supply pipe. A filter assembly connected in-line to the filter loop.

### CROSS-REFERENCE TO RELATED APPLICATIONS

This application claims the benefit of U.S. Provisional Application No. 63/352,072, filed Jun. 14, 2022, with is hereby incorporated by reference in its entirety.

### FIELD

The present specification relates generally to refrigeration, and more particularly to large-scale refrigeration systems and cooling towers.

### BACKGROUND

Cooling towers are used in commercial and industrial sites across the world for refrigeration. They vary in size from roof-top boxes to large towers several hundred feet tall. Most cooling towers are installed on top of or next to the building to which the cooling tower supplies refrigeration. All cooling towers draw air in from the environment and exhaust it back out into the open.

Many buildings are deeply reliant on the continuous and uninterrupted operation of their cooling tower or towers. For example, a grocery store will have at least one, but sometimes two or three, cooling towers to handle all the in-store refrigeration needs. Such towers help supply the conditioned environmental air to the store, the cooled air to the meat and dairy sections, and the freezing air to the frozen-food compartments. If a cooling tower stops operating, the grocery store must quickly repair it, bring in a replacement, start stocking dry-ice, or allow its inventory to spoil at great cost. Many other buildings are just as dependent on the conditioned air provided by a cooling tower.

The operation of a cooling tower is fairly simple. It is a large heat exchanger, using the transfer of thermal energy or heat between fluid and gas to cool air before it returns to the building. External air is pulled into the housing of the cooling tower by a large turbine, and passed over copper tubing containing freon. Water is sprayed onto the copper tubing and evaporates in the presence of the blown air. Heat in the freon is drawn off by the evaporation, and the cold freon is then passed to other parts of the building to condition air.

Cooling towers operate best when they are kept clean and within preferred operating ranges. This is difficult to do. Because cooling towers are open to the environment, they are especially susceptible to four types of damage: corrosion, scaling, fouling, and microbiological activity. All of these reduce the efficiency of heat transfer and thus the overall effectiveness of the cooling tower. In places like Arizona, for example, where the external air can be dirty and filled with dust and other debris, the cooling towers can quickly become dirtied and require cleaning to remove scaling or build-up on the copper tubes. Most buildings have crews which perform regular maintenance to clean the tower and prevent it from falling into disrepair.

A necessary part of cooling tower operation is dumping of soiled water. Because cooling towers operate in the open, dirt will always enter the system. Commercial entities spend a great deal of money on the maintenance crews who regularly clean the tower. Those crews are quite effective at reducing the amount of dirt circulating within a cooling tower and at reducing scaling on the copper tubes.

The crews work cooperatively with the cooling tower to keep the cooling tower clean. Between regular visits from cleaning crews, the cooling tower dumps water. If a predetermined threshold of contaminants accumulates in the system, the cooling tower will dump some amount of water to reduce the number of contaminants in the system. In some systems, especially large ones, the cooling tower may almost continuously dump water to maintain the desired system ranges. This can represent a tremendous usage of water, with some cooling towers dumping millions of gallons of soiled water each year. To date, this has been an inevitable cost of operating a cooling tower. However, an improved cooling tower presents a good opportunity for water, environmental, and money savings.

### SUMMARY

In an embodiment, a cooling tower system includes a cooling tower housing, a basin and spray nozzles within the cooling tower housing, and a supply pipe configured to transmit a fluid from the basin to the spray nozzles. A filter loop is coupled to the supply pipe. A filter assembly is connected in-line to the filter loop.

In embodiments, an upstream valve couples the filter loop to the supply pipe, and a downstream valve couples the filter loop to the supply pipe. The downstream valve is located downstream of the upstream valve. The filter loop includes an upstream filter line extending from the supply pipe to the filter assembly. The filter loop includes a downstream filter line extending from the filter assembly to the supply pipe. An upstream valve couples the supply pipe to the upstream filter line. A downstream valve couples the downstream filter line to the supply pipe. The upstream valve diverts approximately one-third of the fluid in the supply pipe to the upstream filter line. The upstream valve is a three-way valve and the downstream valve is a one-way valve. The filter assembly includes a centrifugal filter housing and a centrifugal filter contained within the filter housing. The filter is removable and replaceable from the filter housing.

In an embodiment, a cooling tower system includes a cooling tower housing, a basin and spray nozzles within the cooling tower housing, and a supply pipe configured to transmit a fluid from the basin to the spray nozzles. A filtration system is disposed between the basin and the spray nozzles. The filtration system includes a filter loop coupled to the supply pipe, and a filter assembly connected in-line to the filter loop.

In embodiments, the supply pipe includes an upstream section, an intermediate section, and a downstream section. An upstream valve is in the supply pipe between the upstream section and the intermediate section. A downstream valve is in the supply pipe between the intermediate section and the downstream section. An upstream filter line extends between the upstream valve and the filter assembly, and a downstream filter line extending between the filter assembly and the downstream valve. The upstream valve has a first position, in which the upstream valve directs all fluid in the upstream section of the supply pipe to the intermediate section of the supply pipe. The upstream valve has a second position, in which the upstream valve directs a portion of the fluid in the upstream section of the supply pipe to the intermediate section of the supply pipe and directs another portion of the fluid in the upstream section of the supply pipe to the filter loop. The filter assembly includes a centrifugal filter housing and a centrifugal filter contained within the centrifugal filter housing.

In an embodiment, a cooling tower system includes a cooling tower housing, a basin and spray nozzles within the cooling tower housing, and a supply pipe configured to transmit a fluid from the basin to the spray nozzles. A filtration system is connected to the supply pipe between the basin and the spray nozzles. The filtration system includes a filter loop coupled to the supply pipe, and a filter assembly connected in-line to the filter loop.

In embodiments, the supply pipe includes an upstream section, an intermediate section, and a downstream section. An upstream valve is in the supply pipe between the upstream section and the intermediate section. A downstream valve is in the supply pipe between the intermediate section and the downstream section. The filter loop includes an upstream filter line extending between the upstream valve and the filter assembly, and a downstream filter line extending between the filter assembly and the downstream valve. The upstream valve has a first position, in which the upstream valve directs all fluid in the upstream section of the supply pipe to the intermediate section of the supply pipe. The upstream valve has a second position, in which the upstream valve directs a portion of the fluid in the upstream section of the supply pipe to the intermediate section of the supply pipe and another portion of the fluid in the upstream section of the supply pipe to the filter loop. The portion is approximately two-thirds and the other portion is approximately one-third. The filter assembly includes a centrifugal filter housing and a centrifugal filter contained within the centrifugal filter housing. The centrifugal filter is removable and replaceable from the filter housing.

The above provides the reader with a very brief summary of some embodiments described below. Simplifications and omissions are made, and the summary is not intended to limit or define in any way the disclosure. Rather, this brief summary merely introduces the reader to some aspects of some embodiments in preparation for the detailed description that follows.

### BRIEF DESCRIPTION OF THE DRAWINGS

Referring to the drawings:

FIG. 1 is a generalized schematic of a cooling tower with an improved filtration system; and

FIG. 2 is a perspective view of a portion of the cooling tower with an improved filtration system.

### DETAILED DESCRIPTION

Reference now is made to the drawings, in which the same reference characters are used throughout the different figures to designate the same elements. Briefly, the embodiments presented herein are preferred exemplary embodiments and are not intended to limit the scope, applicability, or configuration of all possible embodiments, but rather to provide an enabling description for all possible embodiments within the scope and spirit of the specification. Description of these preferred embodiments is generally made with the use of verbs such as “is” and “are” rather than “may,” “could,” “includes,” “comprises,” and the like, because the description is made with reference to the drawings presented. One having ordinary skill in the art will understand that changes may be made in the structure, arrangement, number, and function of elements and features without departing from the scope and spirit of the specification. Further, the description may omit certain information which is readily known to one having ordinary skill in the art to prevent crowding the description with detail which is not necessary for enablement. Indeed, the diction used herein is meant to be readable and informational rather than to delineate and limit the specification; therefore, the scope and spirit of the specification should not be limited by the following description and its language choices.

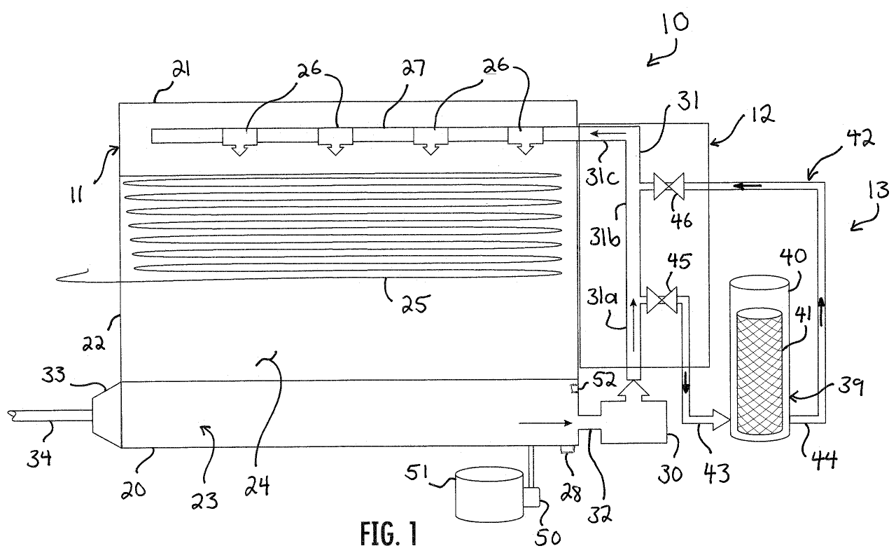

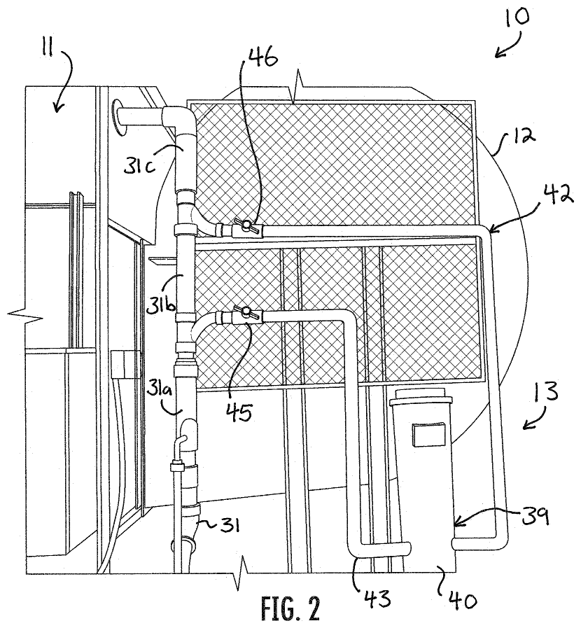

FIG. 1 shows a schematic of an improved cooling tower system 10 (also referred to herein as just “cooling tower 10”), and FIG. 2 shows a photograph of an embodiment of the improved cooling tower 10. The tower 10 has a large cooling housing 11, a fan box 12 mounted to the side of the cooling housing 11 and coupled in fluid communication with the cooling housing 11, and a filtration system 13 next to the housing 11. The filtration system 13 shown and described here can be added to existing cooling towers and can also be included during construction of new cooling towers.

The cooling tower 10 shown in FIGS. 1 and 2 is exemplary; it illustrates but one of many possible configurations for cooling towers. Generally, cooling towers move a great volume of air and as such are large structures. The cooling housing 11 of this cooling tower 10 is a large, preferably metallic, housing or box. It has a closed bottom 20, an opposed open top 21, and a four-sided sidewall 22 extending therebetween. The fan box 12 is mounted to one of the sides to force or draw air through the housing 11 and out the open top 21.

At the bottom of the cooling housing 11 is a basin 23 (herein referred to as “water basin 23”), which is a reservoir for holding a fluid (preferably water) within the cooling tower 10. Above the water basin 23, the housing 11 has a largely open interior 24. A plurality of tubes 25 are supported at an elevated position within the interior 24 of the housing 11 above the water basin 23. The tubes 25 are shown here as lines, but they are tubes or pipes. In some embodiments, there may be only a single tube 25 which routes back and forth within the housing 11 (as shown here), while in other embodiments, there are several tubes 25 within the housing 11. The tubes 25 within the housing 11 are preferably constructed from copper tubing and carry cold freon. The tubes 25 enter and exit the housing 11 through the sidewall 22 of the housing 11.

From the cooling tower 10, the tubes 25 route and extend to a compressor or compressors located elsewhere in the building. The tubes 25 are oriented horizontally across the interior 24 of the housing 11, forming an array therein. The tubes are located roughly in a middle vertical portion of the interior 24. Though shown schematically in FIG. 1 as a single tube turning back and forth from near the top 21 of the housing down to the middle of the interior 24, it should be understood that the tubes 25 may also extend the width of the interior. In other words, they may be routed within one horizontal plane, or within several horizontal planes, so as to occupy a cross-sectional space of the housing 11.

Above the tubes 25 are a set of spray heads or nozzles 26. These nozzles 26 are mounted in line with and as part of a spray pipe or pipes 27. The nozzles 26 are directed downwardly from just below the top 21 of the cooling housing 11 to spray water down onto the tubes 25. This helps evaporatively cool the tubes 25 and, in turn, cool the freon inside the tubes 25.

The water sprayed out of the nozzles 26 is supplied by a pump 30. Preferably, the pump 30 is located outside of the housing 11 but still near the housing 11. In FIG. 1, the pump 30 is shown, for exemplary purposes and not to limit the disclosure, next to the water basin 23. The pump 30 is connected to a power supply and is capable of operating on AC or DC power.

A supply pipe 31 extends vertically from the pump 30 to provide and transmit water from the water basin 23 to the spray pipe 27 and ultimately the spray nozzles 26. In FIG. 1, it appears that the supply pipe 31 through around the fan box 12, but it preferably extends around it, along the outside of the fan box 12. A pump pipe 32 supplies water to the pump 30. Here, the pump pipe 32 is shown as very short. The pump pipe 32 is connected between the water basin 23 and the pump 30.

When the pump 30 is operating, water in the water basin 23 is drawn into the pump pipe 32 and then into the pump 30. The pump 30 moves the water up, through the supply pipe 31 and then into the spray pipe 27. The water next sprays out of each of the nozzles 26 near the top 21 of the housing 11. This water sprays down over the tubes 25 as a fine mist. The mist lands on the tubes 25 where it collects. The fan box 12 blows air up through the interior 24 and over those tubes 25, evaporating the mist and cooling the freon in the tubes 25.

The fan box 12 is coupled to the housing 11 at an opening in the sidewall 22 of the housing 11. The fan box 12 contains a large fan, fans, or other set of impellers that draw a large volume of external air at a rapid rate. For clarity of the drawings, FIG. 1 does not show the fan in the fan box 12, but one having ordinary skill in the art will understand that the fan is preferably, but not necessarily, an axially-mounted fan or a centrifugal fan (FIG. 2 depicts a fan box 12 for a centrifugal fan). Typically, a mesh screen, grill, or other gross filter is on the outside of the fan box 12 to keep large items out of the fan. The fan box 12 blows air into the interior 24 of the housing 11.

Generally, the top 21 of the housing 11 is either completely open or covered with a screen or louvers. Regardless of the construction of the top 21, the air blown into the interior 24 of the cooling housing 11 exits through the top 21 without interruption. Evaporated water and air are released though the top of the cooling housing 11 through drift eliminators.

During operation, there is water loss. Some of the water sprayed out of the nozzles 26 is inevitably blown straight out of the top 21 where it is lost to the environment. Water that evaporates in the forced air moving over the tubes also is blown out the top 21. Thus, the cooling tower 10 is not a closed system; water is continuously leaving the cooling tower 10.

The cooling tower 10 also loses water through a dumping system. Because the cooling tower 10 is open to the environment, dust, dirt, and debris can enter the interior 24 and contaminate the water within the interior 24. Ultimately, these contaminations end up in the water basin 23. As a result, the cooling tower 10 has a dumping process.

Soiled water is dumped or drained from the water basin 23 at a solenoid-controlled drain 28 to ensure that the circulating water is sufficiently clean. The water in the water basin 23 therefore is replaced. A float 33 coupled in fluid communication to the water basin 23 controls the provision of water from an inlet pipe 34.

The float 33 may be mechanical, electrical, or electromechanical, such as an electronic sensor or ball-style float. When the float 33 detects the water level in the water basin 23 has dropped below a predetermined threshold, the float 33 opens the inlet pipe 34 and supplies fresh water to the water basin 23. This newly-introduced water is “fresh” or “makeup” water.

The filtration system 13 greatly reduces the need to supply makeup water. In cooling towers 10 equipped with the filtration system 13, the water in the interior 24 and in the water basin 23 is cleaner and thus does not have to be dumped nearly so often. Without continuous dumping of soiled water and re-supplying of makeup water, the cooling tower 10 with the filtration system 13 saves huge volumes of water. Maintaining cleaner water also mitigates biological activity within the cooling tower 10, prevents frequent fouling or scaling on the tubes 25, and eases the workload of the maintenance crew who clean the cooling tower 10.

The filtration system 13 includes a filter assembly 39 and a filter loop 42. The filtration assembly 39 includes a housing 40 containing a filter 41. It is connected to the cooling housing 11 with the filter loop 42. The filter loop 42 is a pipe assembly that connects from an upstream end of the supply pipe 31 to a downstream end of the supply pipe 31. Briefly, the terms “upstream” and “downstream” are used here with respect to the flow of water through the cooling tower 10 and the filtration system 13, which generally is in a counter-clockwise direction in FIGS. 1 and 2, as indicated by the unmarked arrows in FIG. 1. The terms “upstream” and “downstream” refer to directions as well as various arrangements or relative arrangements of structures or features with respect to each other.

The filter housing 40 shown here is cylindrical and preferably uses centrifugal action to filter water passing through the housing 40. In such embodiments, the filter housing 40 is a centrifugal housing and the filter 41 is a centrifugal filter 41. The filter housing 40 may have other configurations. The filter housing 40 contains the filter 41 and provides access to remove the filter 41 and replace it with a new filter 41 as needed.

The filter 41 is any suitable filter but preferably a pleated jumbo micron filter for reducing contaminants as small as five microns in dimension. In operation, a larger filter 41 is preferably initially installed in the filter housing 40 and run. Later, smaller filters can be used. For example, some users may find it preferable to use a forty-micron filter for the first few weeks of operation of the cooling tower 10 and filtration system 13. After a few weeks, some users may remove the larger filter 41 and replace it with a smaller filter, such as a five-micron filter. That filter can then be cleaned periodically and reused instead of being replaced. The inventors have found this to be an effective method for reducing total dissolved solids in the system water. Total dissolved solids end up in the water basin 23 and force the cooling tower 10 to dump the water from the basin 23 to the drain 28 in order to reduce fouling, scaling, and other issues. By reducing the total dissolved solids with the above method, the water basin 23 needs to be dumped less frequently, resulting in considerable water savings. Additionally, reducing the total dissolved solids helps prevent scaling on the tubes 25, which improves heat transfer. The inventors have found that at steady-state operation of the cooling tower 10 (which is generally defined at least by continuous running of the cooling tower 10) and the filtration system 13, the cooling tower 10 uses approximately twenty-eight percent to approximately thirty-seven percent less energy than a similarly-sized cooling tower operating without the filtration system 13.

The filtration housing 40 is coupled in fluid communication on and with the filter loop 42. The filter loop 42 includes an upstream filter line 43 providing water to the filtration housing 40 from the cooling housing 11 and a downstream filter line 44 returning water to the cooling housing 11 from the filtration housing 40. The upstream and downstream filter lines 43 and 44 are both pipes connected in fluid communication to the filter housing 40.

The upstream and downstream filter lines 43 and 44 are also both coupled to the supply pipe 31. Valves 45 and 46 are disposed proximate the junctures formed by the supply pipe 31 and each of the filter lines 43 and 44. The valves 45 and 46 allow the filter housing 40 to be selectively coupled to or decoupled from the supply pipe 31 in fluid communication. It is noted here that FIG. 1 shows the valves 45 and 46 in front of, not within, the fan box 12. Like the supply pipe 31, the valves are preferably not located within the fan box 12.

In FIGS. 1 and 2, the valves 45 and 46 are shown carried in the upstream and downstream lines 43 and 44, respectively. This is an efficient set up when modifying an existing cooling tower, and FIGS. 1 and 2 are used to illustrate how such a modification could be made. However, in other embodiments, such as in new construction, the valves 45 and 46 are formed in-line with the supply pipe 31. For this reason, the valves 45 and 46 separate the supply pipe 31 into three distinct sections. A first section, or upstream section 31a of the supply pipe 31, is upstream of the valve 45. A second section, or intermediate section 31b of the supply pipe 31, is between the valves 45 and 46. And a third section, or downstream section 31c of the supply pipe 31, is downstream of the valve 46. The upstream, intermediate, and downstream sections 31a, 31b, and 31c all cooperate to form the single, continuous supply pipe 31 extending from the pump 30 to the spray pipe 27.

The valve 45 is identified here as an upstream valve 45 and couples the upstream line 43 to the supply pipe 31. In embodiments, the valve 45 is a three-way valve. In such embodiments, the upstream valve 45 has a first position, in which the upstream valve 45 directs all water flowing from the upstream section 31a of the supply pipe 31 into the intermediate section 31b of the supply pipe 31. In the first position of the upstream valve 45, no water flows into the upstream line 43 of the filter loop 42. The upstream valve 45 also has a second position, in which the upstream valve 45 directs a portion of the water flowing from the upstream section 31a of the supply pipe 31 into the intermediate section 31b of the supply pipe 31 and another portion of the water flowing from the upstream section 31a into the upstream line 43 of the filter loop 42. The upstream valve 45 also has a third position, which enables the flow of water from the supply pipe 31 to the upstream line 43. In the first position, the upstream valve 45 directs all water flowing from the upstream section 31a of the supply pipe 31 to the upstream line 43 only.

The valve 46 is identified here as a downstream valve 46 and couples the downstream line 44 to the supply pipe 31. The downstream valve 46 is preferably a one-way valve. In a first position of the downstream valve 46, water from the filter housing 40 can only exit the downstream line 44 and return to the supply pipe 31 to the spray nozzles 26. In other words, water flowing from the downstream line 44 flows only to the downstream section 31c of the supply pipe 31. Preferably, in the first position, water from the intermediate section 31b also flows to the downstream section 31c. In a second position, water from the filter housing 40 is entirely prevented from passing from the downstream line 44 to the supply pipe 31. In other words, in the second position, the downstream valve 46 only passes water coming from the intermediate section 31b to the downstream section 31c.

However, in other embodiments, the downstream valve 46 has other configurations. In such other embodiments, the downstream valve 46 has a first position, which enables the flow of water from the downstream line 44 to the downstream section 31c of the supply pipe 31. In the first position, water flows only from the downstream line 44 to the downstream section 31c of the supply pipe 31. In a second position, water only flows through the supply pipe 31 and no water flows from the downstream line 44 to the supply pipe 31. In a third position, some water flows from the downstream line 44 to the downstream section 31c of the supply pipe 31 and some water also flows from the intermediate section 31b through the downstream valve 46 to the downstream section 31c of the supply pipe 31.

The upstream valve 45 is located downstream from the pump 30, so that during operation, water is pumped from the pump 30 through the supply pipe 31 and into the upstream line 43 to the filtration housing 40.

Preferably, however, the upstream valve 45 is placed in its second position, so that not all of the water in the supply pipe 31 is re-routed through the upstream line 43. Rather, only a portion of the water is re-routed. The upstream valve 45 directs the water through both the intermediate section 31b of the supply pipe 31 and the upstream line 43 of the filter loop 42.

Preferably, when the upstream valve 45 is in the second position, it routes approximately one-third of the water flowing through the upstream section 31a of the supply pipe 31 through the downstream line 43 of the filter loop 42. The remaining water—here, preferably approximately two-thirds—flows immediately up the intermediate section 31b of the supply pipe 31 and into the spray pipe 27, where water then sprays out the nozzles 26. Thus, only some of the water is filtered in the filtration housing 40. The inventors have found that diverting approximately one-third of the water to the filter assembly 39 ensures that sufficient water reaches the spray nozzles 26 to continue evaporative cooling but also ensures that the water circulating in the system is filtered and cleaned. Diverting more water than one-third can damage the filter assembly 39, or at least hamper its performance, and causes the cooling tower 10 to operate inefficiently. For example, in the dry Arizona summer, diverting too much water to the filter assembly 39 can lead to too much evaporation within the cooling tower 10, which creates problems because the inlet pipe 34 may be unable to supply water to the water basin 23 fast enough. And diverting less water generally fails to clean the circulating water adequately.

Another pump 50 supplies chemicals from a chemical basin or drum 51 to the water basin 23. This helps control biological activity and the growth of microorganisms in the water. Preferably, the chemistry within the cooling tower 10 and the filtration system 13 is controlled by the pump 50 to limit organic phosphates in the water to a range of six to ten parts per million. Initially, the pump 50 dispenses chemicals to achieve an organic phosphate level of twelve parts per million. Movement of water through the filtration system 13 reduces that level of twelve parts per million. Periodically, a tech samples the water and measures the organic phosphate levels to determine how much chemical the pump 50 should inject into the water. A conductivity controller 52 on the cooling tower 10 has a probe in the water basin 23 which monitors the total dissolved solids and the water conductivity. When the total dissolved solids reaches a pre-determined threshold, the conductivity controller 52 instructs the solenoid-controlled drain 28 to open and dump water (which in turn triggers the float 33 to supply makeup water) as necessary to maintain the organic phosphates in the water to the preferred range of six to ten parts per million. Reducing the total dissolved solids reduces scaling on the tubes 25, which contributes to energy savings for the cooling tower 10, as noted above.

In operation, the fan box 12 and the pump 30 both run continuously. Water in the water basin 23 circulates through the cooling tower 10 and its filtration system 13. Water is drawn into the pump 30, pumped up the supply pipe 31, and out through the nozzles 26. The sprayed water falls onto the copper tubes 25 to draw heat from the freon therein. The fan box draws air into the interior 24 of the housing 11, but that air is not clean, as it is pulled externally from the environment and can contain dust, bugs, and other contaminants. The water which is not blown out of the top of the cooling tower 10 collects in the water basin 23 and carries some of those contaminants. However, when the valves 45 and 46 are arranged to join the filtration system 13 in fluid communication with the rest of the cooling tower 10, the water in the water basin 23 is filtered.

Some of the water pumped out of the pump 30 is diverted through the upstream valve 45 to the upstream line 43 and into the filtration housing 40 and filter 41, where the contaminants are largely removed. The filtered water is then returned along the downstream line 44 through the downstream valve 46, the supply pipe 31, the spray pipe 27, and finally out the spray nozzles 26. In this way, rather than the recirculating water continuing to be dirtied and dumped, the water is cleaned and recycled within the system.

Cleaned water lacks the suspended solids, organics, and silt particles which exist in a conventional cooling tower. This reduces the likelihood of fouling of the tower 10 and biological growth in the water and on the tower 10 components. This, in turn, reduces the amount of scaling and corrosion that occurs, which maintains efficiency of thermal transfer across the copper tubes. And a significantly lesser amount of water needs to be dumped from the cooling tower 10, and so a significantly lesser amount of water needs to be made up from a fresh supply. This allows the cooling tower 10 to consume and waste far less water and require less maintenance than conventional cooling towers.

A preferred embodiment is fully and clearly described above so as to enable one having skill in the art to understand, make, and use the same. Those skilled in the art will recognize that modifications may be made to the description above without departing from the spirit of the specification, and that some embodiments include only those elements and features described, or a subset thereof. To the extent that modifications do not depart from the spirit of the specification, they are intended to be included within the scope thereof.

What is claimed is:

1. A cooling tower system comprising:
a cooling tower housing;
a basin and spray nozzles within the cooling tower housing, and a supply pipe configured to transmit a fluid from the basin to the spray nozzles;
a filter loop coupled to the supply pipe; and
a filter assembly connected in-line to the filter loop.

2. The cooling tower system of claim 1, further comprising:
an upstream valve coupling the filter loop to the supply pipe; and
a downstream valve coupling the filter loop to the supply pipe, the downstream valve located downstream of the upstream valve.

3. The cooling tower system of claim 1, wherein:
the filter loop includes an upstream filter line extending from the supply pipe to the filter assembly;
the filter loop includes a downstream filter line extending from the filter assembly to the supply pipe;
an upstream valve couples the supply pipe to the upstream filter line; and
a downstream valve couples the downstream filter line to the supply pipe.

4. The cooling tower system of claim 3, wherein the upstream valve diverts approximately one-third of the fluid in the supply pipe to the upstream filter line.

5. The cooling tower system of claim 3, wherein the upstream valve is a three-way valve and the downstream valve is a one-way valve.

6. The cooling tower system of claim 1, wherein the filter assembly includes a centrifugal filter housing and a centrifugal filter contained within the filter housing.

7. The cooling tower of claim 6, wherein the centrifugal filter is removable and replaceable from the centrifugal filter housing.

8. A cooling tower system comprising;
a cooling tower housing;
a basin and spray nozzles within the cooling tower housing, and a supply pipe configured to transmit a fluid from the basin to the spray nozzles; and
a filtration system disposed between the basin and the spray nozzles.

9. The cooling tower system of claim 8, wherein:
the supply pipe includes an upstream section, an intermediate section, and a downstream section;
an upstream valve is in the supply pipe between the upstream section and the intermediate section; and
a downstream valve is in the supply pipe between the intermediate section and the downstream section.

10. The cooling tower system of claim 9, wherein the filtration system comprises:
a filter loop coupled to the supply pipe; and
a filter assembly connected in-line to the filter loop.

11. The cooling tower system of claim 10, wherein the filter assembly includes a centrifugal filter housing and a centrifugal filter contained within the centrifugal filter housing.

12. The cooling tower system of claim 10, wherein:
the upstream valve has a first position, in which the upstream valve directs all fluid in the upstream section of the supply pipe to the intermediate section of the supply pipe; and
the upstream valve has a second position, in which the upstream valve directs a portion of the fluid in the upstream section of the supply pipe to the intermediate section of the supply pipe and directs another portion of the fluid in the upstream section of the supply pipe to the filter loop.

13. The cooling tower system of claim 12, wherein the filter loop includes:
an upstream filter line extending between the upstream valve and the filter assembly; and
a downstream filter line extending between the filter assembly and the downstream valve.

14. A cooling tower system comprising:
a cooling tower housing;
a basin and spray nozzles within the cooling tower housing, and a supply pipe configured to transmit a fluid from the basin to the spray nozzles;
a filtration system connected to the supply pipe between the basin and the spray nozzles, the filtration system comprising:
a filter loop coupled to the supply pipe; and
a filter assembly connected in-line to the filter loop.

15. The cooling tower system of claim 14, wherein:
the supply pipe includes an upstream section, an intermediate section, and a downstream section; and
an upstream valve is in the supply pipe between the upstream section and the intermediate section; and
a downstream valve is in the supply pipe between the intermediate section and the downstream section.

16. The cooling tower system of claim 15, wherein the filter loop includes:
an upstream filter line extending between the upstream valve and the filter assembly; and
a downstream filter line extending between the filter assembly and the downstream valve.

17. The cooling tower system of claim 16, wherein:
the upstream valve has a first position, in which the upstream valve directs all fluid in the upstream section of the supply pipe to the intermediate section of the supply pipe; and
the upstream valve has a second position, in which the upstream valve directs a portion of the fluid in the upstream section of the supply pipe to the intermediate section of the supply pipe and another portion of the fluid in the upstream section of the supply pipe to the filter loop.

18. The cooling system of claim 17, wherein the portion is approximately two-thirds and the other portion is approximately one-third.

19. The cooling tower system of claim 14, wherein the filter assembly includes a centrifugal filter housing and a centrifugal filter contained within the centrifugal filter housing.

20. The cooling tower of claim 19, wherein the centrifugal filter is removable and replaceable from the filter housing.
